(19) United States
(12) Patent Application Publication
(10) Pub. No.: US 2025/0023623 A1
(43) Pub. Date: Jan. 16, 2025

(54) ADAPTIVE BEAM MEASUREMENT PERIODICITY

(71) Applicant: Samsung Electronics Co., Ltd., Suwon-si (KR)

(72) Inventors: Mustafa Furkan Ozkoc, The Colony, TX (US); Jianhua Mo, Allen, TX (US); Jeehwan Noh, Suwon-si (KR); Hyejin Kim, Suwon-si (KR); Young Han Nam, Plano, TX (US)

(21) Appl. No.: 18/596,568

(22) Filed: Mar. 5, 2024

Related U.S. Application Data
(60) Provisional application No. 63/526,919, filed on Jul. 14, 2023.

(51) Int. Cl. H04B 7/08; H04W 24/10

(52) U.S. Cl. CPC H04B 7/088; H04W 24/10

(57) ABSTRACT

A method includes determining a beam measurement periodicity for beam reporting by a user equipment (UE) for use in beam tracking. The method also includes performing beam tracking according to the beam measurement periodicity. The method also includes adaptively increasing or decreasing the beam measurement periodicity based on information related to at least one of a UE measurement report, a current network state, a UE state, or a previously observed network behavior. The method also includes performing additional beam tracking according to the adaptively increased or decreased beam measurement periodicity.

### CROSS-REFERENCE TO RELATED APPLICATIONS AND CLAIM OF PRIORITY

The present application claims priority to U.S. Provisional Patent Application No. 63/526,919 filed on Jul. 14, 2023. The content of the above-identified patent document is incorporated herein by reference.

### TECHNICAL FIELD

The present disclosure relates generally to wireless communication systems and, more specifically, the present disclosure relates to a system and method for adaptive beam measurement periodicity.

### BACKGROUND

Beam management is an important and required procedure in mmWave frequencies. The mmWave beam codebook design is very important and challenging for 5G mmWave base stations. Different from the low frequency bands, beamforming is needed to support the high data transmission at the mm Wave band due to the large mmWave band path-loss. A significant number of beams (e.g., more than 100 beams) may be needed to cover a wide angular region, for example, horizontally from −60 degrees to +60 degrees. On the other hand, many reference signals are needed to find out the best beam between the base station (BS) and the user equipment (UE).

### SUMMARY

The present disclosure relates to wireless communication systems and, more specifically, the present disclosure relates to a system and method for adaptive beam measurement periodicity.

In one embodiment, a method includes determining a beam measurement periodicity for beam reporting by a user equipment (UE) for use in beam tracking. The method also includes performing beam tracking according to the beam measurement periodicity. The method also includes adaptively increasing or decreasing the beam measurement periodicity based on information related to at least one of a UE measurement report, a current network state, a UE state, or a previously observed network behavior. The method also includes performing additional beam tracking according to the adaptively increased or decreased beam measurement periodicity.

In another embodiment, a device includes a transceiver and a processor operably connected to the transceiver. The processor is configured to: determine a beam measurement periodicity for beam reporting by a UE for use in beam tracking; perform beam tracking according to the beam measurement periodicity; adaptively increase or decrease the beam measurement periodicity based on information related to at least one of a UE measurement report, a current network state, a UE state, or a previously observed network behavior; and perform additional beam tracking according to the adaptively increased or decreased beam measurement periodicity.

In yet another embodiment, a non-transitory computer readable medium includes program code that, when executed by a processor of a device, causes the device to: determine a beam measurement periodicity for beam reporting by a UE for use in beam tracking; perform beam tracking according to the beam measurement periodicity; adaptively increase or decrease the beam measurement periodicity based on information related to at least one of a UE measurement report, a current network state, a UE state, or a previously observed network behavior; and perform additional beam tracking according to the adaptively increased or decreased beam measurement periodicity.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example beamforming architecture according to embodiments of the present disclosure;

FIG. 5 illustrates an example of a composite beam transmission using a single antenna array according to embodiments of the present disclosure;

FIGS. 6A and 6B illustrate an example process for adaptive beam measurement periodicity according to embodiments of the present disclosure;

FIGS. 7A and 7B illustrate another example process for adaptive beam measurement periodicity according to embodiments of the present disclosure;

FIGS. 8A and 8B illustrate yet another example process for adaptive beam measurement periodicity according to embodiments of the present disclosure;

FIGS. 9A and 9B illustrate an example process where the adaptive periodicity algorithm can be turned on/off based on the hierarchical relationship between the reported NB and WB indices, according to embodiments of the present disclosure;

FIG. 10 illustrates an example training phase of an adaptive periodicity algorithm with site-specific learning, according to embodiments of the present disclosure;

FIGS. 11A and 11B illustrates an example process using the application phase of adaptive periodicity algorithm with site-specific learning, according to embodiments of the present disclosure;

FIG. 12 illustrates an example process for adaptive beam measurement periodicity utilizing UE speed information, according to embodiments of the present disclosure; and

FIG. 13 illustrates a method for adaptive beam measurement periodicity according to embodiments of the present disclosure.

### DETAILED DESCRIPTION

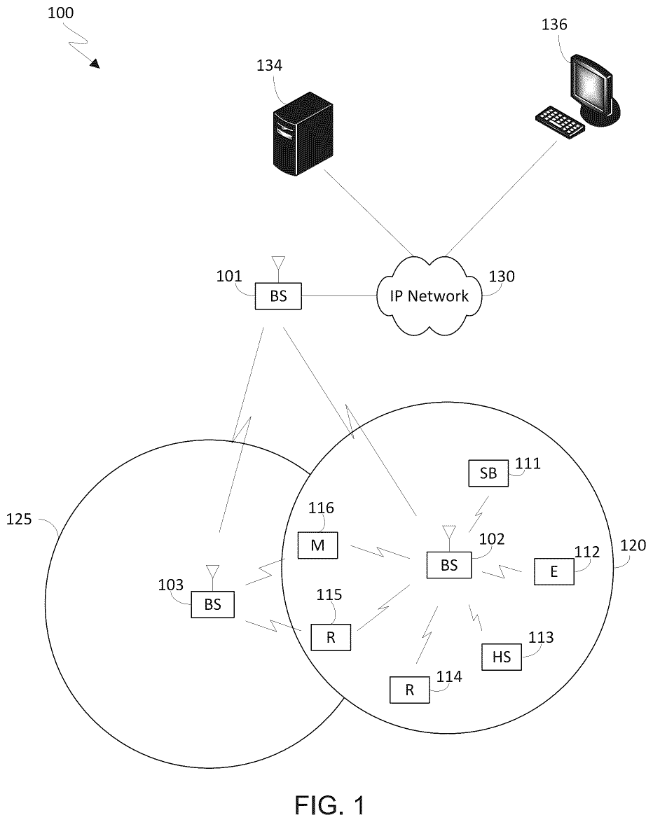

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

In some embodiments, the network 130 facilitates communications between at least one server 134 and various client devices, such as a client device 136. The server 134 includes any suitable computing or processing device that can provide computing services for one or more client devices. The server 134 could, for example, include one or more processing devices, one or more memories storing instructions and data, and one or more network interfaces facilitating communication over the network 130.

The client device 136 represents any suitable computing or processing device that interacts with at least one server or other computing device(s) over the network 130. In this example, the client device is represented as a desktop computer, but other examples of client devices can include a mobile telephone, laptop computer, or tablet computer. However, any other or additional client devices could be used in the wireless network 100.

In this example, client devices can communicate indirectly with the network 130. For example, some client devices can communicate via one or more base stations, such as cellular base stations or eNodeBs. Also, client devices can communicate via one or more wireless access points (not shown), such as IEEE 802.11 wireless access points. Note that these are for illustration only and that each client device 136 could communicate directly with the network 130 or indirectly with the network 130 via any suitable intermediate device(s) or network(s).

As described in more detail below, a computing device, such as the server 134 or the client device 136, may perform operations in connection with beam management. For example, the server 134 or the client device 136 may perform operations in connection with adaptive beam measurement periodicity as discussed herein.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

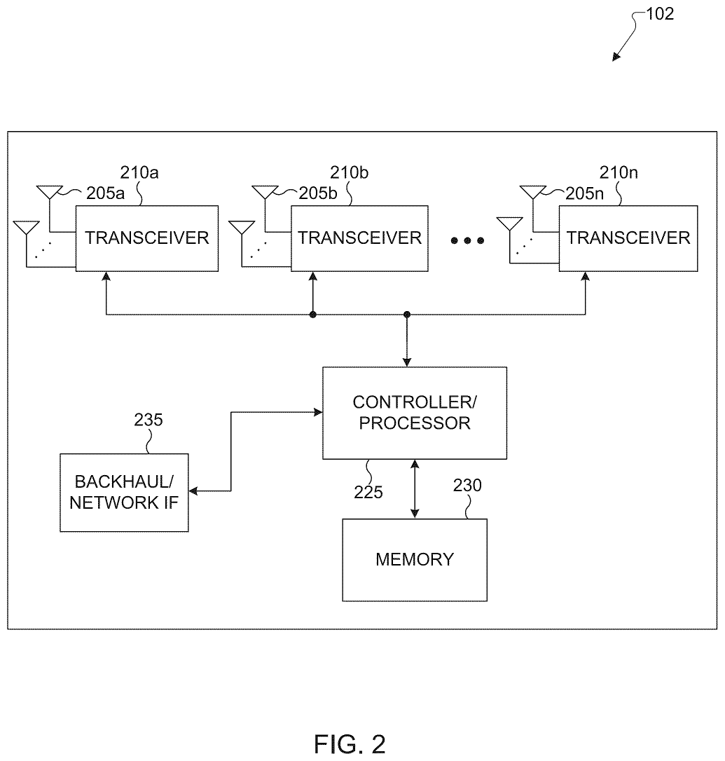

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support adaptive beam measurement periodicity as discussed herein. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

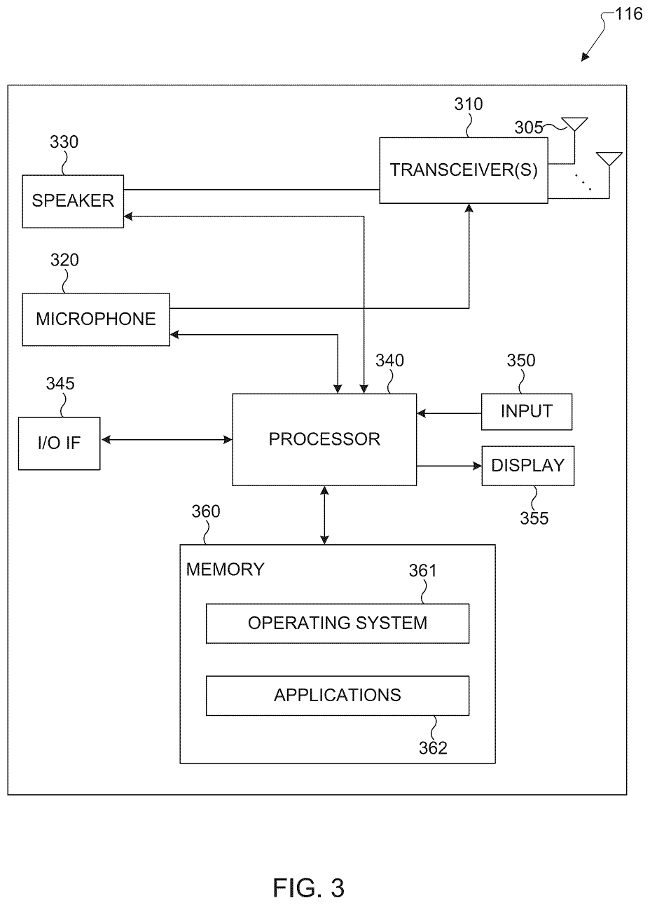

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for adaptive beam measurement periodicity. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 (which includes for example, a touchscreen, keypad, etc.) and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

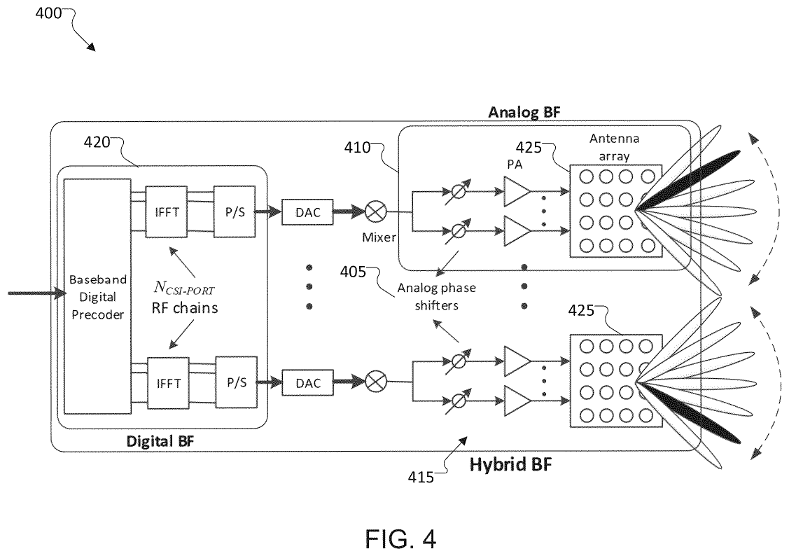

FIG. 4 illustrates an example beamforming architecture 400 according to embodiments of the present disclosure. The embodiment of the beamforming architecture 400 illustrated in FIG. 4 is for illustration only. FIG. 4 does not limit the scope of this disclosure to any particular implementation of the beamforming architecture 400. In certain embodiments, one or more of gNB 102 or UE 116 can include the beamforming architecture 400. For example, one or more of antenna 205 and its associated systems or antenna 305 and its associated systems can be configured the same as or similar to the beamforming architecture 400.

Rel.14 LTE and Rel.15 NR support up to 32 channel state information reference signal (CSI-RS) antenna ports which enable an eNB to be equipped with a large number of antenna elements (such as 64 or 128). In this case, a plurality of antenna elements is mapped onto one CSI-RS port. For mm Wave bands, although the number of antenna elements can be larger for a given form factor, the number of CSI-RS ports-which can correspond to the number of digitally precoded ports-tends to be limited due to hardware constraints (such as the feasibility to install a large number of analog-to-digital converts/digital-to-analog converts (ADCs/DACs at mm Wave frequencies)).

In the example shown in FIG. 4, the beamforming architecture 400 includes analog phase shifters 405, an analog beamformer (BF) 410, a hybrid BF 415, a digital BF 420, and one or more antenna arrays 425. In this case, one CSI-RS port is mapped onto a large number of antenna elements in antenna arrays 425, which can be controlled by the bank of analog phase shifters 405. One CSI-RS port can then correspond to one sub-array which produces a narrow analog beam through analog beamforming by analog BF 410. The analog beam can be configured to sweep across a wider range of angles by varying the phase shifter bank 405 across symbols or subframes. The number of sub-arrays (equal to the number of RF chains) is the same as the number of CSI-RS ports NCSI-PORT. The digital BF 420 performs a linear combination across NCSI-PORT analog beams to further increase precoding gain. While analog beams are wideband (hence not frequency-selective), digital precoding can be varied across frequency sub-bands or resource blocks.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

Additionally, the beamforming architecture 400 is also applicable to higher frequency bands such as >52.6 GHz (also termed the FR4). In this case, the beamforming architecture 400 can employ only analog beams. Due to the O2 absorption loss around 60 GHz frequency (˜10 decibels (dB) additional loss @100 m distance), larger numbers of and sharper analog beams (hence larger number of radiators in the array) will be needed to compensate for the additional path loss.

As discussed above, beam management is an important and required procedure in mmWave frequencies. The mmWave beam codebook design is very important and challenging for 5G mm Wave base stations. Different from the low frequency bands, beamforming is needed to support the high data transmission at the mmWave band due to the large mmWave band path-loss. A significant number of beams (e.g., more than 100 beams) may be needed to cover a wide angular region, for example, horizontally from −60 degrees to +60 degrees. On the other hand, many reference signals are needed to find out the best beam between the BS and the UE. Hierarchical beam codebooks can be used where a large number of narrow beams cover an area for high gain, while a smaller number of wide beams cover the area and limit the synchronization signal blocks (SSBs) overhead. The wide beams and narrow beams have a parent-child relationship. Beam tracking can be achieved using the parent-child relationship by identifying the best wide beam, and then searching for the best narrow beam among the children of the wide beam.

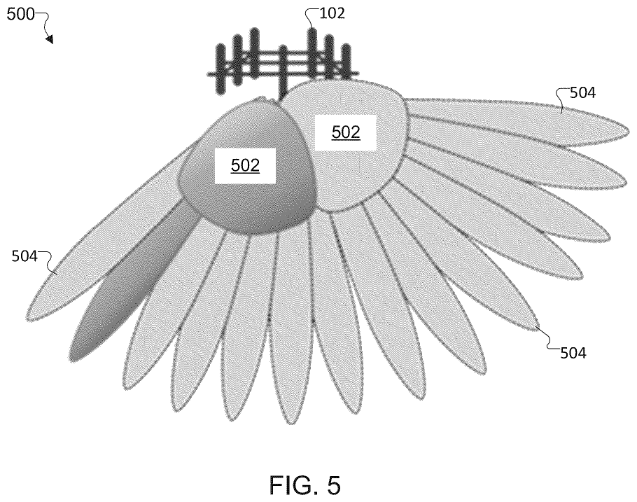

FIG. 5 illustrates an example of a composite beam transmission using a single antenna array 500 according to embodiments of the present disclosure. The antenna array 500 is for illustration only and other embodiments can be used without departing from the scope of the present disclosure.

As shown in FIG. 5, the antenna array 500 can be a component of, for example, the BS 102, and can transmit two wide beams 502 and fourteen narrow beams 504, where each wide beam 502 has seven children narrow beams 504. The example only shows the beam distribution in one dimension. In a hierarchical beam search, the two wide beams 502 are first transmitted by the BS 102 in order to identify the best wide beam 502. Then the BS 102 transmits the seven narrow beams 504 belonging to the best wide beam 502 to a UE (such as the UE 116). The UE measures the signal quality (e.g., RSRP, RSRQ, SNR, CQI, or the like) of the seven narrow beams 504 and feeds back to the BS 102. The narrow beam search is performed for each UE connected to the BS 102 and is performed periodically (e.g., every 80 ms) to track the UE movement or any change of propagation environment.

The narrow beam tracking incurs overhead in both downlink and uplink channels. First, in the downlink channel, each narrow beam measurement creates CSI-RS overhead. Second, once the narrow beams 504 are measured, the UE will report the measurement results to the BS 102 resulting in uplink overhead.

This disclosure provides systems and methods for adaptive beam measurement periodicity. In particular, the disclosed embodiments feature one or more algorithms to change (i.e., increase or decrease) measurement periodicity according to information present in UE measurement reports. Depending on the reports, a suitable measurement report periodicity could be 80 milliseconds (ms), 120 ms, 240 ms, 480 ms, or any other suitable duration, as compared to the 120 ms baseline. A longer measurement periodicity could reduce the downlink and uplink signaling overhead without performance loss in suitable scenarios. A shorter measurement periodicity could improve the beam tracking accuracy.

Some of the embodiments discussed below are described in the context of mmWave bands. Of course, these are merely examples. It will be understood that the principles of this disclosure may be implemented in any number of other suitable contexts, systems, or frequency bands. It is also noted that although some examples describe measurements of RSRP, the UE measurements of the channel could be reference signal received quality (RSRQ), channel quality indicator (CQI), signal-to-noise-ratio (SNR), signal-to-interference-noise-ratio (SINR), and the like. The embodiments in this disclosure can be applied to those measurement metrics as well.

In some embodiments, the measurement periodicity for beam tracking can be adaptively increased or decreased according to information present in UE measurement reports and other information related to the current network and UE state. In some embodiments, the UE state information can include (i) current and previous RSRP measurement reports of the UE; (ii) a UE battery level; (iii) a maximum UE power consumption level; (iv) an application type, a traffic demand, or a reliability requirement of an application executed by the UE; (v) a location, an orientation, a translational speed, or a rotational speed of the UE; or any combination of two or more of these. In some embodiments, the adaptation could leverage RSRP value, beam index, SNR, RSRQ value, CQI, other metrics that are indicative of the system state, or any combination of two or more of these. In other embodiments, the adaptation could leverage the network load information (i.e., traffic load on the network), number of UEs on the network, the deployment site specific information, and other network information.

In some embodiments, the adaptive periodicity algorithm could select and use one measurement periodicity from a fixed set of candidate measurement periodicities. One example of such a set of candidate measurement periodicities could be T_{MRP}=[120, 240, 480] ms. In some embodiments, the adaptive periodicity algorithm could use a fixed step size to increase or decrease the periodicity, such as by 80 ms increments. In some embodiments, the adaptive periodicity algorithm could use a variable step size depending on factors such as (but not limited to) RSRP value, SNR, beam index, and the like.

In one example algorithm, the measurement periodicity can be increased from a current beam measurement periodicity to the smallest beam measurement periodicity in the fixed set that is higher than the current measurement periodicity. For example, when the set of candidate measurement periodicities is T_{MRP}=[120, 240, 480] ms and the current measurement periodicity is 120 ms, the measurement periodicity could be increased to 240 ms, which is the smallest measurement periodicity in T_{MRP} that is higher than 120 ms. In another example, the measurement periodicity can be decreased from a current periodicity to a smaller measurement periodicity, e.g., from 240 ms to 120 ms.

In some embodiments, the serving narrow beam (NB) index, the reported NB RSRP value, and the RSRP history could be the inputs to the adaptive periodicity algorithm, and a fixed set of candidate measurement periodicities T_{MRP} can be used. When a new measurement report is received, the BS can decide whether to increase, decrease, or keep the current measurement periodicity. In one example, if the reported best NB index is different from the serving NB index, then the measurement periodicity can be reduced to the minimum value in the T_{MRP} set. If the reported best NB index is the same as the serving NB index, then the measurement periodicity adaptation can be performed according to the reported RSRP measurement. In one example, if the new received RSRP measurement is higher than the most recent RSRP history value, then the measurement periodicity could be increased. If the new RSRP measurement is the same as the previous RSRP measurement, then the measurement periodicity could be increased or kept the same. If the new RSRP measurement is lower than the previous RSRP measurement, then the measurement periodicity could be reduced or kept the same. A few example actions of adaptive measurement periodicity algorithm are illustrated in Table 1.

TABLE 1
Examples of adaptive periodicity algorithm conditions and actions

| Reported | | | |
|---|---|---|---|
| best NB | | | |
| Index is | | | |
| not equal | | | |
| to the | | | |
| serving | | | |
| NB | Reported best NB Index is not equal to the serving NB Index | | |
| Index | RSRP increased | RSRP is the same | RSRP decreased |
| Use | Increase Periodicity | Increase Periodicity | Increase Periodicity |
| smallest | Increase Periodicity | Increase Periodicity | Maintain Periodicity |
| measurement | Increase Periodicity | Increase Periodicity | Decrease Periodicity |
| periodicity | Increase Periodicity | Maintain Periodicity | Increase Periodicity |
| | Increase Periodicity | Maintain Periodicity | Maintain Periodicity |
| | Increase Periodicity | Maintain Periodicity | Decrease Periodicity |
| | | . | |
| | | . | |
| | | . | |
| | Decrease Periodicity | Decrease Periodicity | Decrease Periodicity |

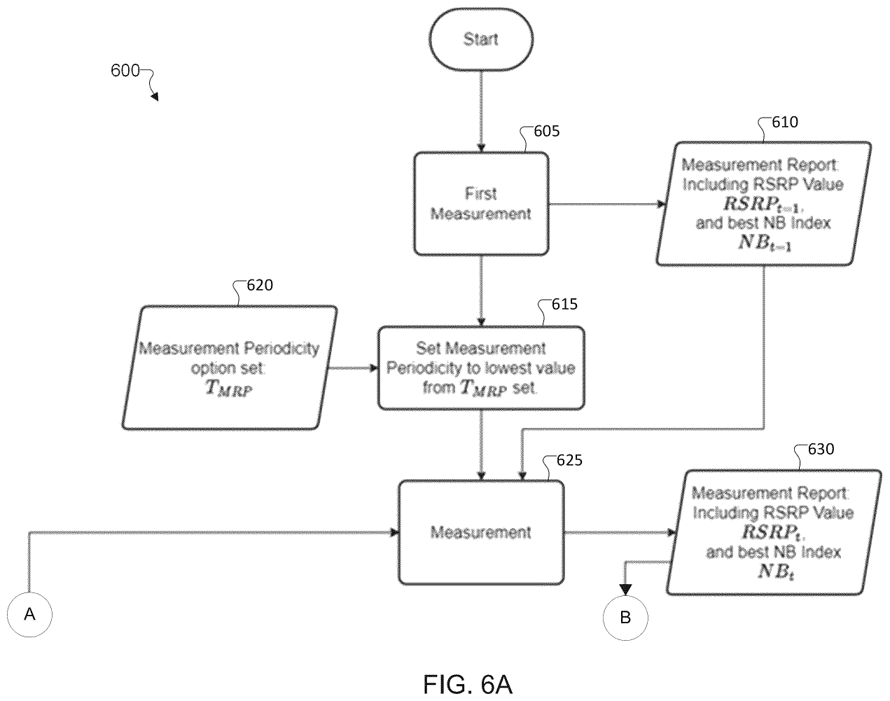

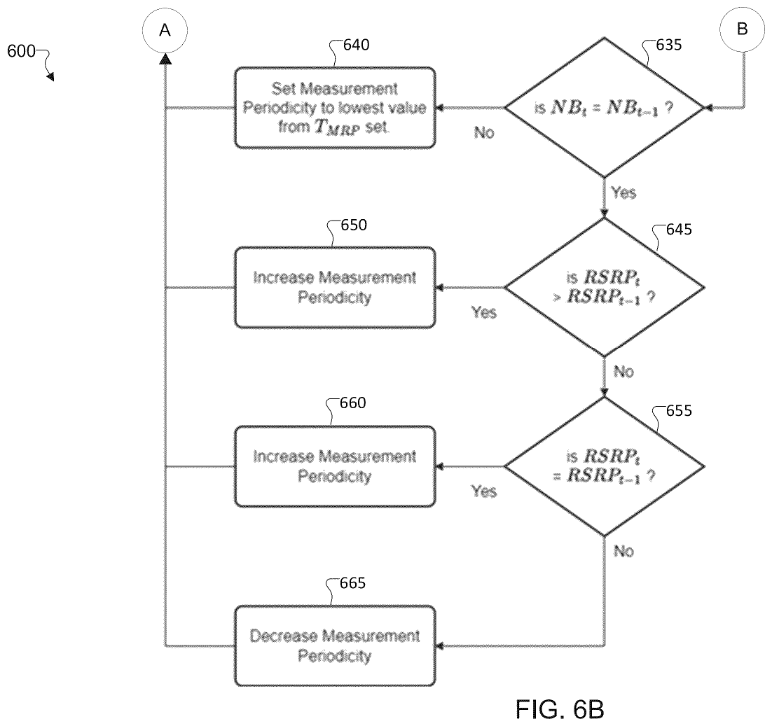

FIGS. 6A and 6B illustrate an example process 600 for adaptive beam measurement periodicity according to embodiments of the present disclosure. For ease of explanation, the process 600 will be described as implemented using the BS 102 and the UE 116 of FIG. 1; however, the process 600 could be implemented by any other suitable device or system. The embodiment of the process 600 shown in FIGS. 6A and 6B is for illustration only. Other embodiments of the process 600 could be used without departing from the scope of this disclosure.

As shown in FIGS. 6A and 6B, the process 600 begins with operation 605, in which the UE 116 takes a first set of measurements related to the current network and UE state. In some embodiments, the measurements could measure RSRP value, beam index, SNR, RSRQ value, CQI, other metrics that are indicative of the system state, or a combination of two or more of these. At operation 610, the UE 116 provides a measurement report to the BS 102. The measurement report can include a current RSRP measurement RSRPₜ₌₁ and a best NB index NBₜ₌₁. At operation 615, the BS 102 sets the current measurement periodicity to a lowest value in a fixed set of candidate measurement periodicities T_{MRP} 620.

Later, at operation 625, the UE 116 takes another set of measurements related to the current network and UE state. At operation 630, the UE 116 provides a new measurement report to the BS 102. The new measurement report can include a current RSRP measurement RSRP, and a best NB index NBₜ.

At operation 635, the BS 102 compares the current best NB index NBₜ to the previous best NB index NBₜ₋₁ and determines if they are equal. If NBₜ is not equal to NBₜ₋₁, then at operation 640, the BS 102 sets the measurement periodicity to the lowest value in the set T_{MRP} 620. Alternatively, if NB, is equal to NBₜ₋₁, then the process 600 moves to operation 645.

At operation 645, the BS 102 compares the current RSRP measurement RSRP, to the previous RSRP measurement RSRPₜ₋₁ and determines if RSRPₜ is greater than RSRPₜ₋₁. If RSRP, is greater than RSRPₜ₋₁, then at operation 650, the BS 102 increases the measurement periodicity to a higher value. Alternatively, if RSRPₜ is less than or equal to RSRPₜ₋₁, then the process 600 moves to operation 655. At operation 655, it is determined if RSRPₜ is equal to RSRPₜ₋₁. If RSRP, is equal to RSRPₜ₋₁, then at operation 660, the BS 102 increases the measurement periodicity to a higher value. Alternatively, if RSRPₜ is less than RSRPₜ₋₁, then at operation 665, the BS 102 decreases the measurement periodicity to a lower value.

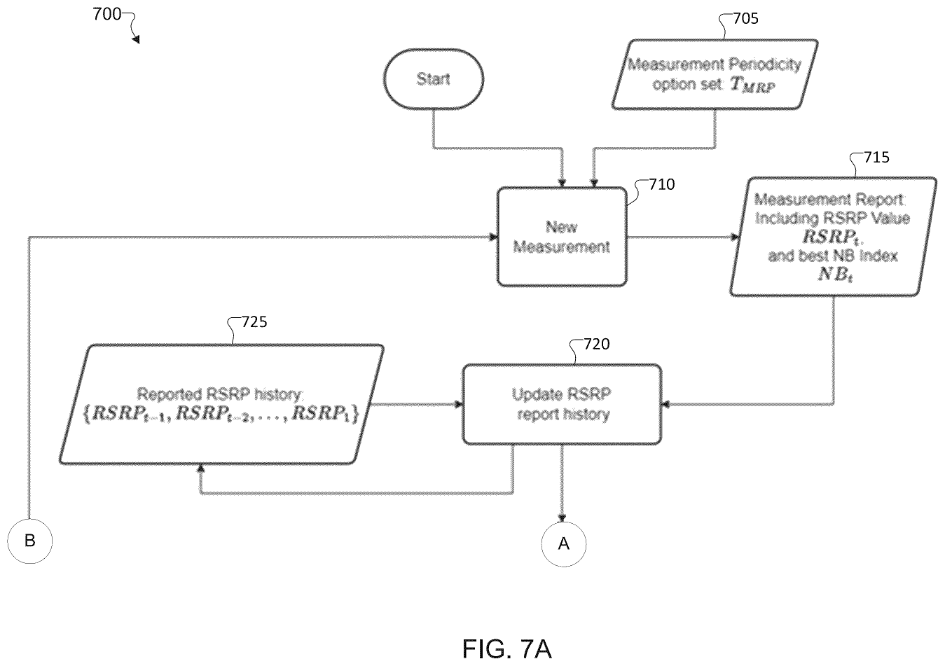

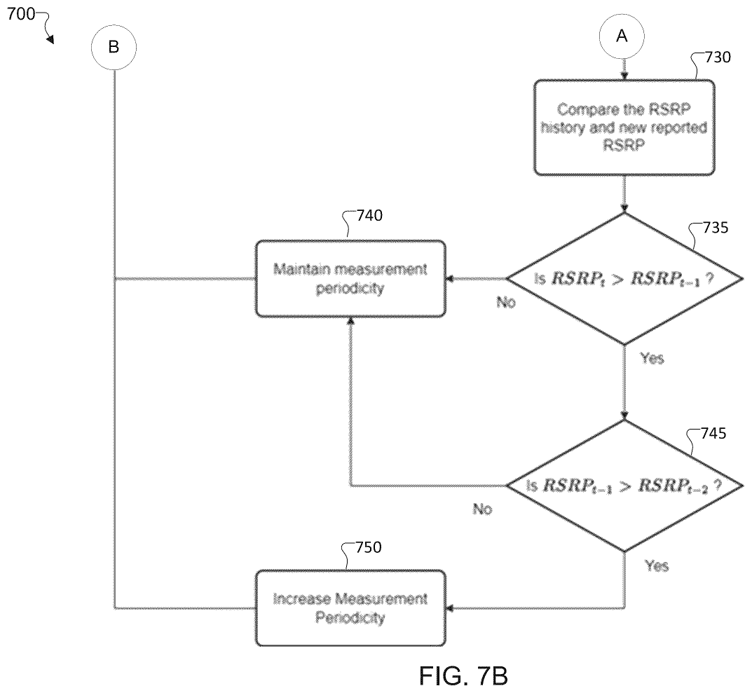

In some embodiments, the BS 102 can use a longer RSRP history to adaptively increase or decrease the measurement periodicity. For example, if the RSRP fluctuation is higher (i.e., the gap between the minimum and maximum RSRP values within a window exceeds a threshold), the measurement periodicity could be reduced. As another example, the measurement periodicity could be increased only when the reported RSRP measurement increases two times consecutively, such as detailed in FIGS. 7A and 7B.

FIGS. 7A and 7B illustrate another example process 700 for adaptive beam measurement periodicity according to embodiments of the present disclosure. Here, the BS 102 uses a longer RSRP history to adaptively increase or decrease the measurement periodicity. For ease of explanation, the process 700 will be described as implemented using the BS 102 and the UE 116 of FIG. 1; however, the process 700 could be implemented by any other suitable device or system. The embodiment of the process 700 shown in FIGS. 7A and 7B is for illustration only. Other embodiments of the process 700 could be used without departing from the scope of this disclosure.

As shown in FIGS. 7A and 7B, the process 700 begins with operation 705, in which the BS 102 sets the current measurement periodicity to a value in a fixed set of candidate measurement periodicities T_{MRP}. At operation 710, the UE 116 takes a new set of measurements related to the current network and UE state. In some embodiments, the measurements could measure RSRP value, beam index, SNR, RSRQ value, CQI, other metrics that are indicative of the system state, or a combination of two or more of these. At operation 715, the UE 116 provides a measurement report to the BS 102. The measurement report can include a current RSRP measurement RSRP, and a best NB index NBₜ.

At operation 720, the BS 102 receives the current RSRP measurement in the measurement report and updates an RSRP report history 725. The RSRP report history 725 is a record of the reported RSRP over time, and contains the t most recent RSRP measurements {RSRPₜ₋₁, RSRPₜ₋₂, . . . , RSRP₁} reported by the UE 116 in the t most recent measurement reports.

At operation 730, the BS 102 compares the RSRP report history 725 and the new reported RSRP measurement RSRP, from the measurement report in operation 715. At operation 735, the BS 102 determines if RSRPₜ is greater than RSRPₜ₋₁. If not, then at operation 740, the BS 102 maintains the current measurement periodicity. Alternatively, if RSRPₜ is greater than RSRPₜ₋₁, then at operation 745, the BS 102 determines if RSRPₜ₋₁ is greater than RSRPₜ₋₂. If not, then at operation 740, the BS 102 maintains the current measurement periodicity. Alternatively, if RSRPₜ₋₁ is greater than RSRPₜ₋₂, then at operation 750, the BS 102 increases the measurement periodicity.

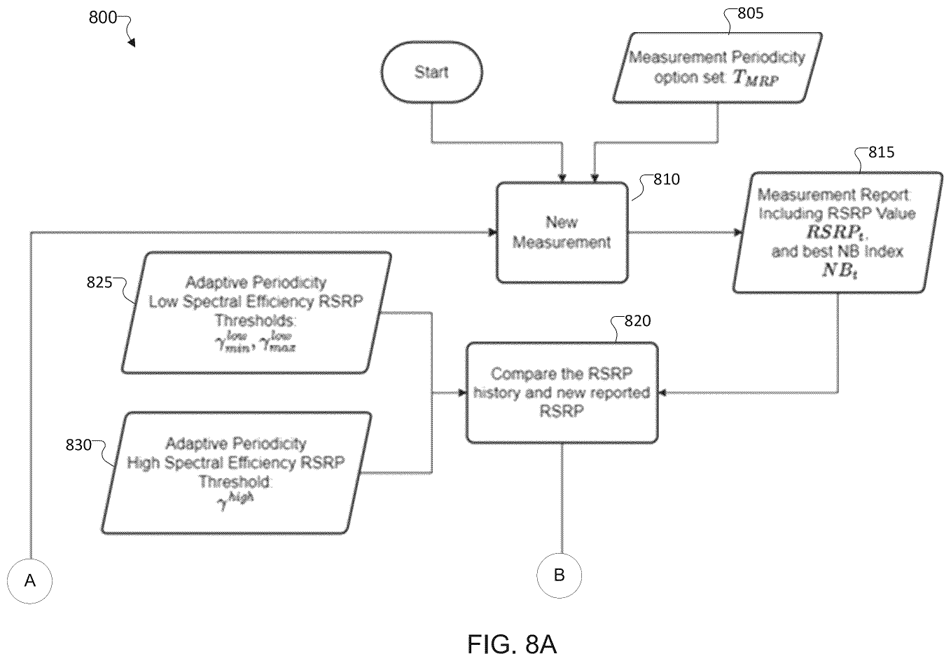

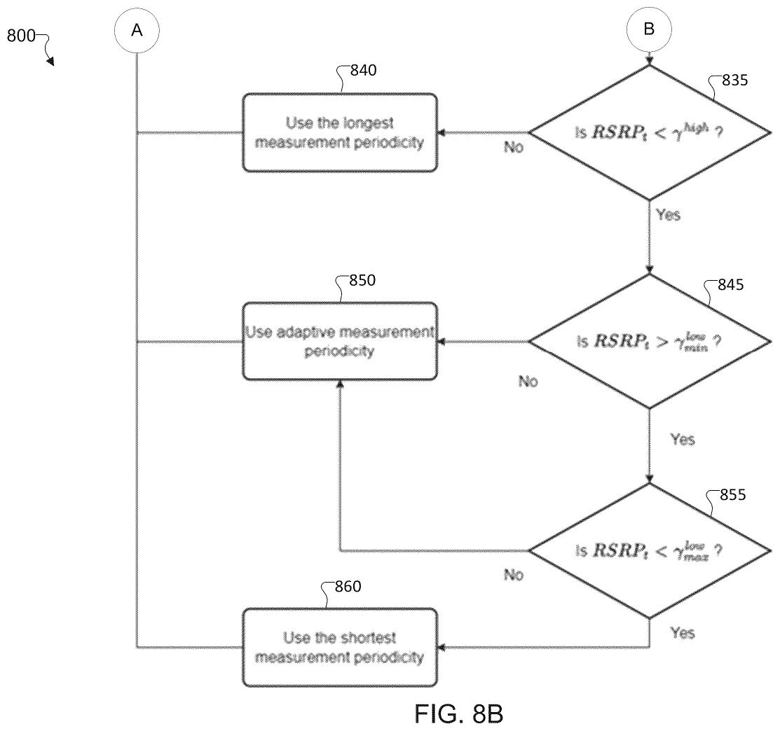

In some embodiments, the adaptive periodicity algorithm can be turned on or off depending on the reported RSRP measurement. When the adaptive periodicity algorithm is turned off, a baseline method with fixed periodicity can be used. In one example, if the RSRP value is too low that the UE is already in an outage, the adaptive periodicity algorithm can be turned on. The aim is to increase the measurement periodicity for UEs that are already in an outage. With a large periodicity, the UE state can be checked less frequently to reduce the overhead. In another example, if the UE is not in an outage but the RSRP value is too low (i.e., corresponding to an SNR value that can only achieve minimum spectral efficiency), the adaptive periodicity algorithm can be turned off, or the shortest measurement periodicity can be used to ensure high beam tracking accuracy. The operation flow of one such example is illustrated in FIGS. 8A and 8B.

FIGS. 8A and 8B illustrate yet another example process 800 for adaptive beam measurement periodicity according to embodiments of the present disclosure. Here, the BS 102 determines measurement periodicity by RSRP thresholds to enable high beam tracking accuracy in a low spectral efficiency state. For ease of explanation, the process 800 will be described as implemented using the BS 102 and the UE 116 of FIG. 1; however, the process 800 could be implemented by any other suitable device or system. The embodiment of the process 800 shown in FIGS. 8A and 8B is for illustration only. Other embodiments of the process 800 could be used without departing from the scope of this disclosure.

As shown in FIGS. 8A and 8B, the process 800 begins with operation 805, in which the BS 102 sets the current measurement periodicity to a value in a fixed set of candidate measurement periodicities T_{MRP}. At operation 810, the UE 116 takes a new set of measurements related to the current network and UE state. In some embodiments, the measurements could measure RSRP value, beam index, SNR, RSRQ value, CQI, other metrics that are indicative of the system state, or a combination of two or more of these. At operation 815, the UE 116 provides a measurement report to the BS 102. The measurement report can include a current RSRP measurement RSRP, and a best NB index NBₜ.

At operation 820, the BS 102 compares the RSRP report history and the new reported RSRP measurement RSRP, from the measurement report in operation 815. Here, the RSRP report history can include adaptive periodicity low spectral efficiency RSRP thresholds 825 (identified as γₘᵢₙ^{low} and γₘₐₓ^{low}) and high spectral efficiency RSRP thresholds 830 (identified as γ^{high}).

At operation 835, the BS 102 determines if RSRPₜ is less than γ^{high}. If not, then at operation 840, the BS 102 changes to the longest measurement periodicity in the set of candidate measurement periodicities T_{MRP}. Alternatively, if RSRPₜ is less than γ^{high}, then at operation 845, the BS 102 determines if RSRPₜ is greater than γₘᵢₙ^{low}. If not, then at operation 850, the BS 102 uses adaptive measurement periodicity. Alternatively, if RSRPₜ is greater than γₘᵢₙ^{low}, then at operation 855, the BS 102 determines if RSRPₜ is less than γₘₐₓ^{low}. If not, then at operation 850, the BS 102 uses adaptive measurement periodicity. Alternatively, if RSRPₜ is less than γₘₐₓ^{low}, then at operation 860, the BS 102 changes to the shortest measurement periodicity in the set of candidate measurement periodicities T_{MRP}.

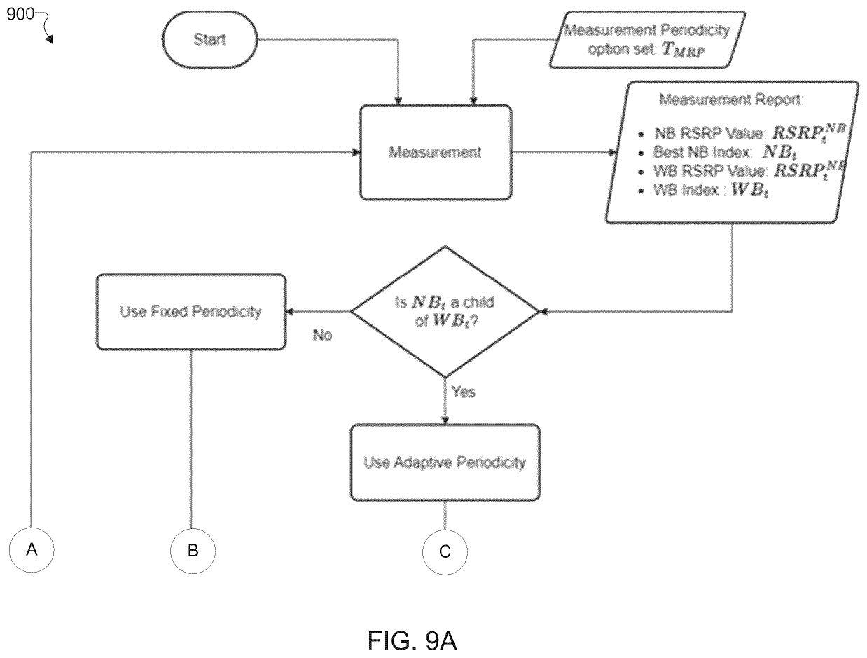

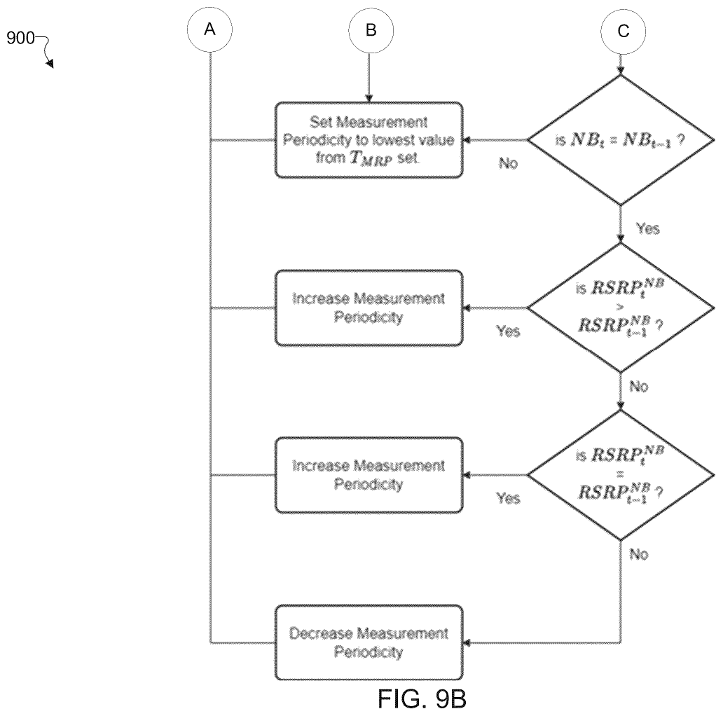

In some embodiments, wide beam (WB) related information can be utilized. This information could include the wide beam index, the reported wide beam RSRP measurement, the history of wide beam RSRP measurements, other wide beam related parameters, or any combination of two or more of these. The information about the hierarchical relation between wide beam and narrow beam indices could also be used. In one example, if the wide beam index and the narrow beam index are not within the hierarchical tree structure (i.e., the NB is not a child of the WB), the measurement periodicity can be set to the smallest possible value in T_{MRP} set. This could improve the beam tracking accuracy, as the mismatch between the wide beam and narrow beam hierarchy is usually one indicative factor for non-line-of-sight (NLOS) channels. The operation flow of one such example process 900 is illustrated in FIGS. 9A and 9B, where the adaptive periodicity algorithm can be turned on/off based on the hierarchical relationship between the reported NB and WB indices.

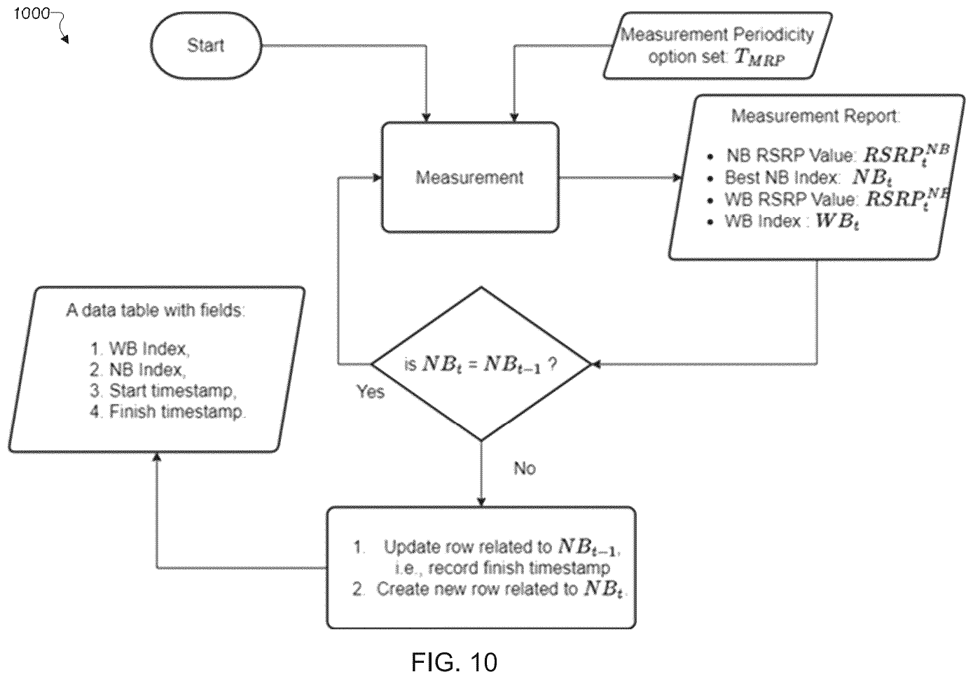

In some embodiments, a site-specific learning approach can be used to decide the measurement periodicity. In one example implementation, during the learning stage, a fixed periodicity beam tracking algorithm can be used. Every time a NB index change is observed, the wide beam and narrow beam indices could be recorded along with a timestamp. The operation flow of one such training process 1000 is illustrated in FIG. 10, which shows the training phase of the adaptive periodicity algorithm with site-specific learning. Once enough site-specific information is collected, the adaptive periodicity algorithm can be turned on. Every time a NB index change is observed, the adaptive periodicity algorithm can query the database, and extract the average time spent in this system state, where the system state could be expressed by the combined NB-WB indices. In one example, if the average time is larger than a threshold, a longer measurement periodicity can be used. Conversely, if the average time is shorter than a threshold, a shorter measurement periodicity can be used. In another example, multiple time parameters could be used to determine the periodicity, including:
1. The current time t.
2. The starting time of the current system state tₛₜₐᵣₜ.
3. The average time spent in such system state t_{WB}_{ₜ}_{,NB}_{ₜ}^{AVG}.
4. The current measurement periodicity Γ_{MRP}.

One way to utilize this information could be increasing the measurement periodicity if the average time left in the system state is larger than the current measurement periodicity, which can be expressed by the following:

$$( {t}_{start} + {t}_{{WB}_{t} , {NB}_{t}}^{AVG} ) - t > {Γ}_{MRP} .$$

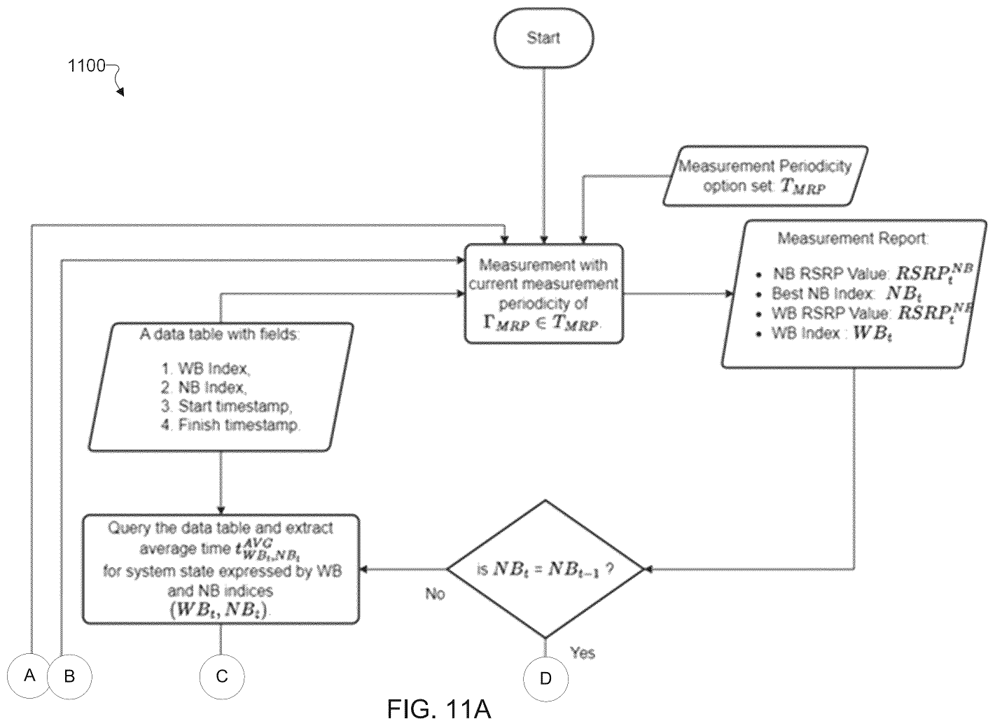

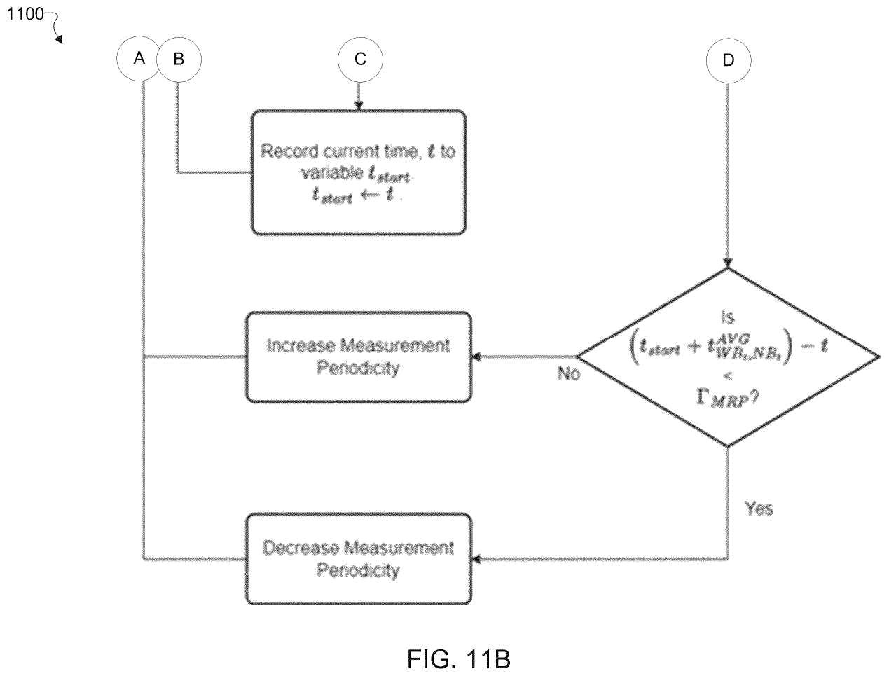

FIGS. 11A and 11B illustrates one such example process 1100 using the application phase of adaptive periodicity algorithm with site-specific learning, according to embodiments of the present disclosure.

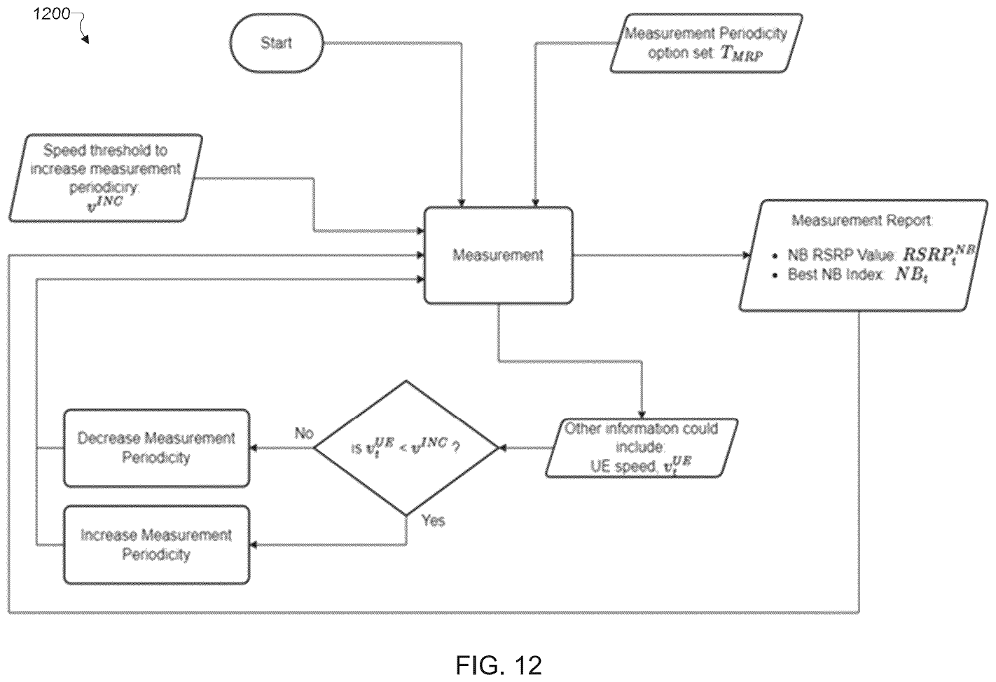

In some embodiments, information related to each UE 116 collected from other sources than the measurement report, or available at the BS 102, can be utilized to decide on measurement periodicity. One such example could utilize the UE speed. The UE speed information could be available at the BS 102 either by explicit UE reports or by estimations using devices such as radar or other methods. If the speed of a UE 116 is low, the UE 116 can stay within each NB for a longer time compared to a UE 116 with high speed. Therefore, the UE speed could be utilized to adjust the measurement periodicity. In one example, for slow speed UEs 116, a larger measurement periodicity could be used, and for high speed UEs 116, a shorter measurement periodicity could be used. FIG. 12 illustrates one example process 1200 for adaptive beam measurement periodicity utilizing UE speed information, according to embodiments of the present disclosure.

Although FIGS. 6A through 12 illustrate various processes and details related to reduced overhead beam tracking, various changes may be made to FIGS. 6A through 12. For example, various components in FIGS. 6A through 12 could be combined, further subdivided, or omitted and additional components could be added according to particular needs. In addition, various operations in FIGS. 6A through 12 could overlap, occur in parallel, occur in a different order, or occur any number of times.

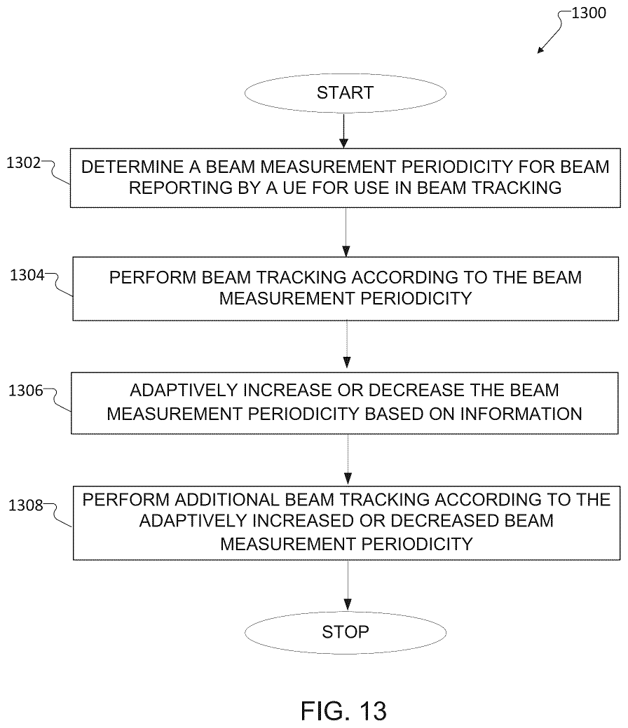

FIG. 13 illustrates a method 1300 for adaptive beam measurement periodicity according to embodiments of the present disclosure, as may be performed by one or more components of the network 100 (e.g., the BS 102). The embodiment of the method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, the method 1300 begins at step 1302.

At step 1302, a base station determines a beam measurement periodicity for beam reporting by a UE for use in beam tracking. This could include, for example, the BS 102 determining a beam measurement periodicity for beam reporting by the UE 116 for use in beam tracking, such as shown in FIGS. 4 and 5. In some embodiments, the BS 102 sets the beam measurement periodicity to a lowest value in the fixed set of candidate measurement periodicities T_{MRP} 620.

At step 1304, the base station performs beam tracking according to the beam measurement periodicity. This could include, for example, the BS 102 performing beam tracking, such as shown in FIGS. 4 and 5.

At step 1306, the base station adaptively increases or decreases the beam measurement periodicity based on information related to at least one of a UE measurement report, a current network state, a UE state, or a previously observed network behavior. This could include, for example, the BS 102 increasing or decreasing the beam measurement periodicity, such as shown in FIGS. 6A through 12.

At step 1308, the base station performs additional beam tracking according to the adaptively increased or decreased beam measurement periodicity. This could include, for example, the BS 102 performing additional beam tracking, such as shown in FIGS. 4 and 5.

Although FIG. 13 illustrates one example of a method 1300 for adaptive beam measurement periodicity, various changes may be made to FIG. 13. For example, while shown as a series of steps, various steps in FIG. 13 could overlap, occur in parallel, occur in a different order, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
determining a beam measurement periodicity for beam reporting by a user equipment (UE) for use in beam tracking;
performing beam tracking according to the beam measurement periodicity;
adaptively increasing or decreasing the beam measurement periodicity based on information related to at least one of a UE measurement report, a current network state, a UE state, or a previously observed network behavior; and
performing additional beam tracking according to the adaptively increased or decreased beam measurement periodicity.

2. The method of claim 1, wherein the current network state comprises at least one of:
current and previous RSRP measurement reports;
a number of UEs on the network; and
a traffic load on the network.

3. The method of claim 1, wherein the UE state comprises at least one of:
current and previous RSRP measurement reports of the UE;
a UE battery level;
a maximum UE power consumption level;
an application type, a traffic demand, or a reliability requirement of an application executed by the UE; and
a location, an orientation, a translational speed, or a rotational speed of the UE.

4. The method of claim 1, wherein adaptively increasing or decreasing the beam measurement periodicity based on the information comprises:
increasing the beam measurement periodicity when (i) a current best narrow beam index and a previous best narrow beam index are the same, and (ii) a current RSRP measurement is greater than a previous RSRP measurement;
increasing the beam measurement periodicity when (i) the current best narrow beam index and the previous best narrow beam index are the same, and (ii) the current RSRP measurement and the previous RSRP measurement are the same;
increasing or decreasing the beam measurement periodicity when (i) the current best narrow beam index and the previous best narrow beam index are the same, and (ii) the current RSRP measurement is less than the previous RSRP measurement; and
changing the beam measurement periodicity to a lowest value when the current best narrow beam index and the previous best narrow beam index are different.

5. The method of claim 1, wherein adaptively increasing or decreasing the beam measurement periodicity based on the information comprises:
increasing the beam measurement periodicity when a current best narrow beam index and a previous best narrow beam index are the same; and
changing the beam measurement periodicity to a lowest value when the current best narrow beam index and the previous best narrow beam index are different.

6. The method of claim 1, wherein adaptively increasing or decreasing the beam measurement periodicity based on the information comprises adaptively selecting the beam measurement periodicity from a fixed set of candidate measurement periodicities, wherein a fixed step size or a variable step size is used to modify the beam measurement periodicity.

7. The method of claim 6, wherein adaptively increasing the beam measurement periodicity comprises changing from a current beam measurement periodicity among the fixed set of candidate measurement periodicities to a smallest beam measurement periodicity in the fixed set of candidate measurement periodicities that is higher than the current beam measurement periodicity.

8. A device comprising:
a transceiver; and
a processor operably connected to the transceiver, the processor configured to:
determine a beam measurement periodicity for beam reporting by a user equipment (UE) for use in beam tracking;
perform beam tracking according to the beam measurement periodicity;
adaptively increase or decrease the beam measurement periodicity based on information related to at least one of a UE measurement report, a current network state, a UE state, or a previously observed network behavior; and
perform additional beam tracking according to the adaptively increased or decreased beam measurement periodicity.

9. The device of claim 8, wherein the current network state comprises at least one of:
current and previous RSRP measurement reports;
a number of UEs on the network; and
a traffic load on the network.

10. The device of claim 8, wherein the UE state comprises at least one of:
current and previous RSRP measurement reports of the UE;
a UE battery level;
a maximum UE power consumption level;
an application type, a traffic demand, or a reliability requirement of an application executed by the UE; and
a location, an orientation, a translational speed, or a rotational speed of the UE.

11. The device of claim 8, wherein to adaptively increase or decrease the beam measurement periodicity based on the information, the processor is configured to:
increase the beam measurement periodicity when (i) a current best narrow beam index and a previous best narrow beam index are the same, and (ii) a current RSRP measurement is greater than a previous RSRP measurement;
increase the beam measurement periodicity when (i) the current best narrow beam index and the previous best narrow beam index are the same, and (ii) the current RSRP measurement and the previous RSRP measurement are the same;
increase or decreasing the beam measurement periodicity when (i) the current best narrow beam index and the previous best narrow beam index are the same, and (ii) the current RSRP measurement is less than the previous RSRP measurement; and
change the beam measurement periodicity to a lowest value when the current best narrow beam index and the previous best narrow beam index are different.

12. The device of claim 8, wherein to adaptively increase or decrease the beam measurement periodicity based on the information, the processor is configured to:
increase the beam measurement periodicity when a current best narrow beam index and a previous best narrow beam index are the same; and
change the beam measurement periodicity to a lowest value when the current best narrow beam index and the previous best narrow beam index are different.

13. The device of claim 8, wherein to adaptively increase or decrease the beam measurement periodicity based on the information, the processor is configured to adaptively select the beam measurement periodicity from a fixed set of candidate measurement periodicities, wherein a fixed step size or a variable step size is used to modify the beam measurement periodicity.

14. The device of claim 13, wherein to adaptively increase the beam measurement periodicity, the processor is configured to change from a current beam measurement periodicity among the fixed set of candidate measurement periodicities to a smallest beam measurement periodicity in the fixed set of candidate measurement periodicities that is higher than the current beam measurement periodicity.

15. A non-transitory computer readable medium comprising program code that, when executed by a processor of a device, causes the device to:
determine a beam measurement periodicity for beam reporting by a user equipment (UE) for use in beam tracking;
perform beam tracking according to the beam measurement periodicity;
adaptively increase or decrease the beam measurement periodicity based on information related to at least one of a UE measurement report, a current network state, a UE state, or a previously observed network behavior; and
perform additional beam tracking according to the adaptively increased or decreased beam measurement periodicity.

16. The non-transitory computer readable medium of claim 15, wherein the current network state comprises at least one of:
current and previous RSRP measurement reports;
a number of UEs on the network; and
a traffic load on the network.

17. The non-transitory computer readable medium of claim 15, wherein the UE state comprises at least one of:
current and previous RSRP measurement reports of the UE;
a UE battery level;
a maximum UE power consumption level;
an application type, a traffic demand, or a reliability requirement of an application executed by the UE; and
a location, an orientation, a translational speed, or a rotational speed of the UE.

18. The non-transitory computer readable medium of claim 15, wherein the program code to adaptively increase or decrease the beam measurement periodicity based on the information comprises program code to:
increase the beam measurement periodicity when (i) a current best narrow beam index and a previous best narrow beam index are the same, and (ii) a current RSRP measurement is greater than a previous RSRP measurement;
increase the beam measurement periodicity when (i) the current best narrow beam index and the previous best narrow beam index are the same, and (ii) the current RSRP measurement and the previous RSRP measurement are the same;
increase or decreasing the beam measurement periodicity when (i) the current best narrow beam index and the previous best narrow beam index are the same, and (ii) the current RSRP measurement is less than the previous RSRP measurement; and
change the beam measurement periodicity to a lowest value when the current best narrow beam index and the previous best narrow beam index are different.

19. The non-transitory computer readable medium of claim 15, wherein the program code to adaptively increase or decrease the beam measurement periodicity based on the information comprises program code to:
increase the beam measurement periodicity when a current best narrow beam index and a previous best narrow beam index are the same; and
change the beam measurement periodicity to a lowest value when the current best narrow beam index and the previous best narrow beam index are different.

20. The non-transitory computer readable medium of claim 15, wherein the program code to adaptively increase or decrease the beam measurement periodicity based on the information comprises program code to adaptively select the beam measurement periodicity from a fixed set of candidate measurement periodicities, wherein a fixed step size or a variable step size is used to modify the beam measurement periodicity.
